(19) United States
(12) Patent Application Publication
(10) Pub. No.: US 2018/0201543 A1
(43) Pub. Date: Jul. 19, 2018

(54) Geometric Shaped Concrete Aggregate

(71) Applicants: Damon Scott Lunsford, Colusa, CA (US); Steven Mark Totman, Colusa, CA (US)

(72) Inventors: Damon Scott Lunsford, Colusa, CA (US); Steven Mark Totman, Colusa, CA (US)

(21) Appl. No.: 15/460,002

(22) Filed: Mar. 15, 2017

Related U.S. Application Data
(60) Provisional application No. 62/446,784, filed on Jan. 16, 2017.

(51) Int. Cl. C04B 20/00

(52) U.S. Cl. CPC C04B 20/0012; C04B 2111/00258

(57) ABSTRACT

The present invention is a manufactured, geometric shaped aggregate intended to replace the gravel or rock aggregate used in a concrete mixture. The geometric shaped aggregate is provided to be solid or hollow. In an embodiment, the hollow aggregate is filled with insulating material or an adhesive solution to fill cracks formed from stress. Electronic components and sensors may be disposed in the hollow aggregate to gather metrics from the solution. In another embodiment, permeable aggregate can allow for moisture mitigation within the concrete structure. The preferred geometric shape of the aggregate is a tetrapod, but other geometric shapes which are known to naturally interweave or intertwine may be used.

### CROSS-REFERENCE TO RELATED APPLICATION(S)

The present application claims priority to U.S. Provisional Patent Application No. 62/446,784 filed on Jan. 16, 2017, entitled “Podcasts Geometric Shapes Aggregate” the entire disclosure of which is incorporated by reference herein.

### BACKGROUND OF THE INVENTION

### 1. Field of Invention

The present invention relates to the field of concrete aggregate, and more specifically manufactured concrete aggregate having geometric shapes.

### 2. Description of Related Art

Concrete is one of the most widely used materials in the construction world. It is versatile, moldable, and sturdy.

A standard concrete recipe consists of an aggregate solution of cement, sand, rock/gravel added, and water. The basic ingredients for making concrete can be found in abundance the world over. Concrete may appear to be the ideal building material, yet there are downsides to this seemingly miracle product.

Concrete has little insulation value of its own. One solution to this problem involves laying down insulative matting or panels. However, this requires an entirely separate process from the mixing, pouring, molding, spreading, and curing required in a typical concrete layout. As a quick solution to provide insulation, foam particles or portions may be mixed into the concrete aggregate. An increase in foam will create an increase in insulation for concrete mix, however it will also cause a decrease in strength.

Secondly, although sturdy and high in compressive strength, concrete has a low tensile strength. Due to its low tensile strength, concrete often needs the benefit of strengthening solutions to keep larger sections from cracking and crumbling. Typically, strengthening is done with steel rods known as rebar (short for reinforcing bar). Another solution is micro-rebar, in which small pieces of rebar are added to the concrete solution to increase strength. While both these methods are successful in increasing the strength of the concrete, they also will add a considerable amount of weight. A normal concrete recipe is heavy by itself, and adding any of the conventional strengthening solutions adds even more weight.

Based on the foregoing, there is a need in the art for a concrete aggregate which provides strength and insulation to a concrete solution while reducing weight.

### SUMMARY OF THE INVENTION

The present invention is a geometric shaped aggregate to replace the gravel or rock aggregate in a concrete solution. In the preferred embodiment, the geometric shaped aggregate has a body which is shaped to promote interweaving amongst the geometric shaped aggregate placed in the concrete solution.

In an embodiment, the geometric shaped aggregate is comprised of plastic. In the preferred embodiment, the geometric shaped aggregate is provided with a tetrapod shape. The tetrapod shape is known to promote interweaving and intertwining.

In one embodiment, the body of the geometric shape is provided as a solid. In another embodiment, the geometric shaped aggregate is hollow. In an embodiment, the hollow body aggregate acts like a container and is filled with various materials and/or electronic components. In one embodiment, the geometric aggregate is filled with an adhesive solution. The adhesive solution is provided to fill cracks or damage, within the concrete solution, caused by stress and tensile failure.

In an embodiment, a radio frequency (RF) micro sensor with antenna may be disposed within the geometric shaped aggregate. Additional sensors may be placed within the hollow body of the aggregate and information provided by the sensors can be transmitted via the RF antenna. To inform on the environment of a structure in areas such as stressing, moisture, temperature, compression and expansion characteristics as well as movement and location readings of the individual sensors, along with any other relevant data mining.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a sectional view of the geometric shaped aggregate in a concrete solution, according to an embodiment of the present invention;

FIG. 2 is a perspective view of the geometric shaped aggregate in a concrete solution, according to an embodiment of the present invention;

FIG. 3 is a perspective view of the geometric shaped aggregate, according to an embodiment of the present invention;

FIG. 4 is a perspective view of the geometric shaped aggregate, according to an embodiment of the present invention;

FIG. 5 is a perspective view of the geometric shaped aggregate in a concrete solution, according to an embodiment of the present invention; and

FIG. 6 is a perspective cutaway view of the geometric shaped aggregate, according to an embodiment of the present invention.

### DETAILED DESCRIPTION OF PREFERRED EMBODIMENTS

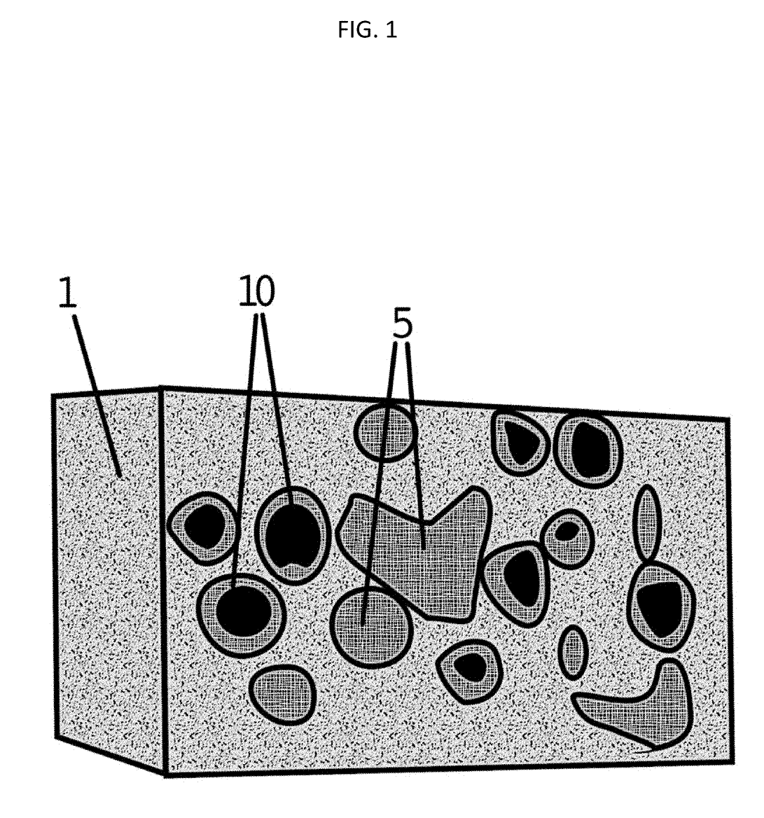

Preferred embodiments of the present invention and their advantages may be understood by referring to FIGS. 1-6, wherein like reference numerals refer to like elements.

In reference to FIG. 1, a sectional view of concrete a concrete block 1 with geometric shape aggregate is shown, according to an embodiment of the present invention. In the preferred embodiment, the concrete is provided with geometric shaped aggregate as solid bodies 5 and hollow bodies 10. In the preferred embodiment, the hollow bodies 10 may be empty (filled with air) or filled with fluid to provided added insulation to the concrete mix. In other embodiments, a hollow body 10 geometric shaped aggregate acts as a container to hold sensors or adhesives.

In the preferred embodiment of the invention, the solid body 5 and hollow body 10 geometric shaped aggregate is comprised of plastic. In the preferred embodiment, the geometric shaped aggregate is manufactured through plastic injection molding. In the embodiment, the geometric shaped aggregate is plastic, however paper, metal, fibers, other recycled materials, natural materials, and sustainable materials may be used.

In the preferred embodiment, the surface of the solid body 5 and hollow body 10 aggregate is solid and textured. The textured surface allows for better adhesion to the concrete solution. In other embodiments, the surface may be smooth or permeable. The permeable surface allows for a flow channel to allow for trapped moisture to percolate and escape from the structure.

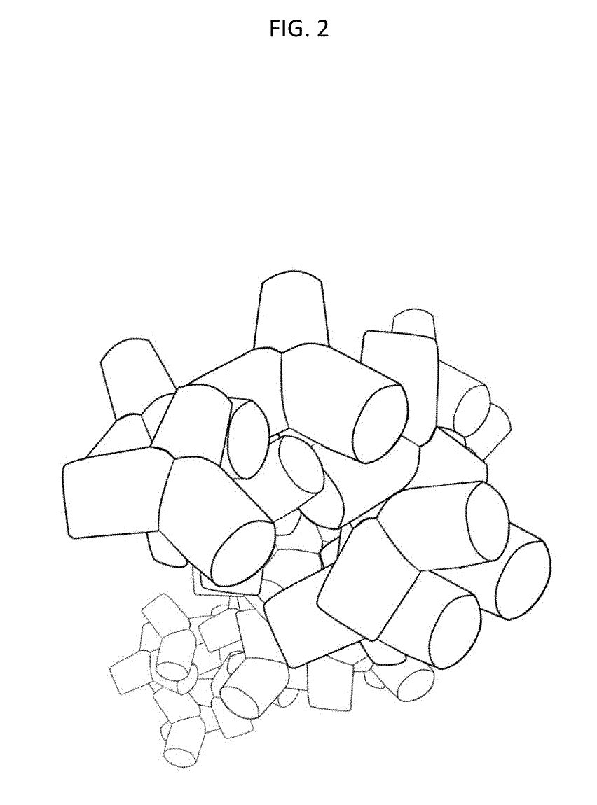

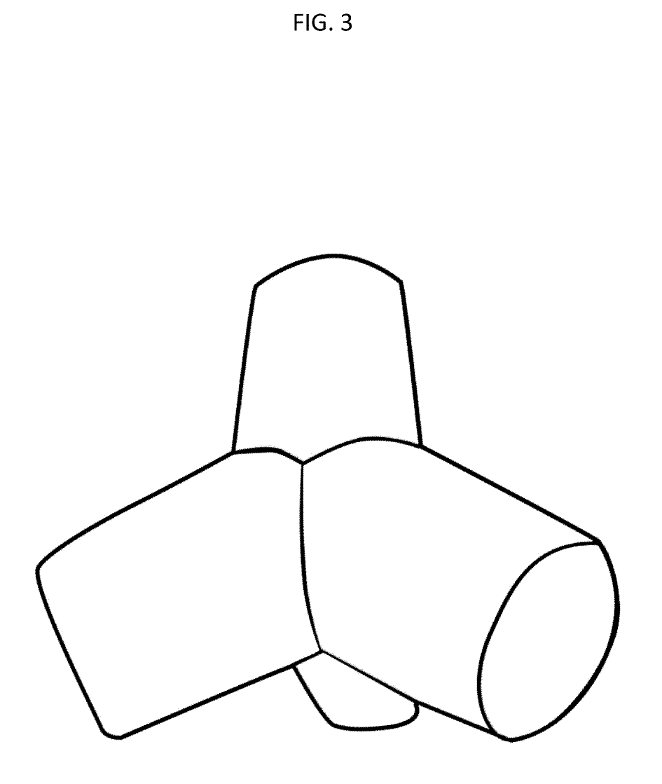

In reference to FIG. 2, a representation of a concrete block 1 is shown filled with geometric shape aggregate. In the embodiment shown, the geometric shaped aggregate is shown having a tetrapod shape. The tetrapod shape allows the geometric shaped aggregate to interweave or intertwine (as shown in FIG. 3) to create additional strengthening and potential for shock wave disbursement qualities.

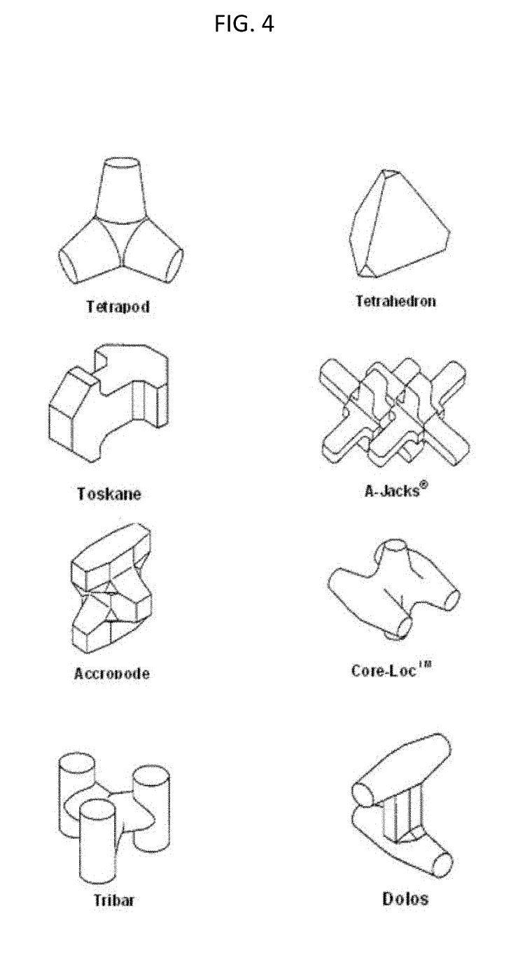

In the preferred embodiment, a tetrapod will be the primary shape of the geometric shaped aggregate. In other embodiments, the geometric shaped aggregate may be shaped as tetrahedrons, tribars, dolos, A-jacks, Core-Locs, or other geometric shapes (as shown in FIG. 4) known in the art, capable of naturally interweaving or intertwining.

In the preferred embodiment, the geometric shaped aggregate will be manufactured to match existing aggregate sizes used for various construction applications. For example, if an application calls for gravel of approximately one inch in diameter, the geometric shaped aggregate can be produced in a size of one inch to replace or compliment the gravel. Adjusting the amount of geometric shaped aggregate in the mix can be used to reduce weight, increase strength, increase the insulation value, or produce a combination of the three improvements. In the preferred embodiment, the geometric shaped aggregate will be mixed and poured exactly like any normal aggregate. There is no need for additional steps to use the geometric shaped aggregate within a concrete mix.

In an embodiment, the ratio of geometric aggregate to concrete mix can be designed to create a concrete which is light and strong enough to float on water.

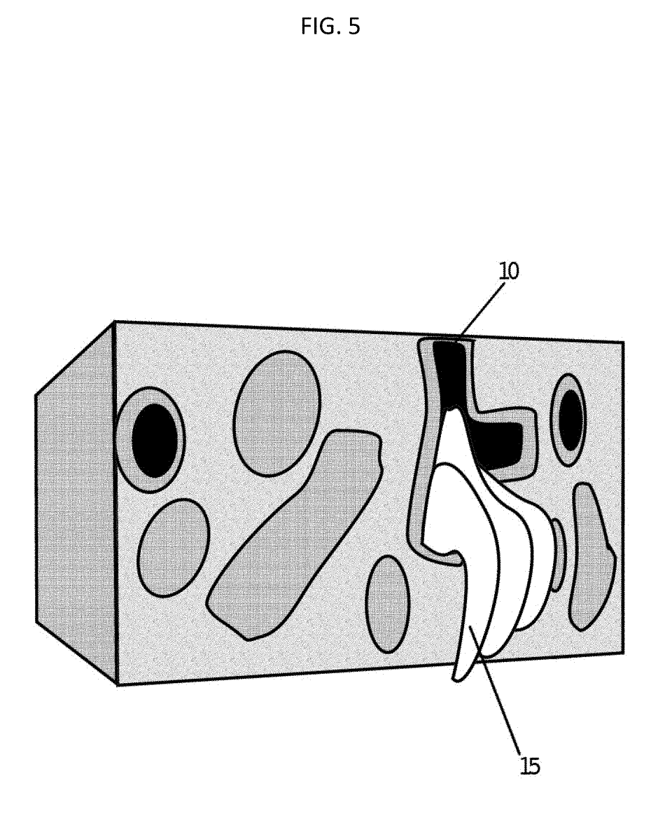

In reference to FIG. 5, an embodiment of the present invention is shown wherein some of the hollow aggregate 10 has been filled with an adhesive 15. In the embodiment, the hollow bodies filled with adhesive may be created with thin walls for a self-healing structure. If the adhesive-filled aggregate ruptures due to damage or stress, then the adhesive is able to seep into the cracks and damaged areas to provide re-adhering to damaged areas. In the preferred embodiment, the adhesive is an epoxy, however the adhesive could be cyanoacrylate, polyurethane, acrylic, or other known adhesives.

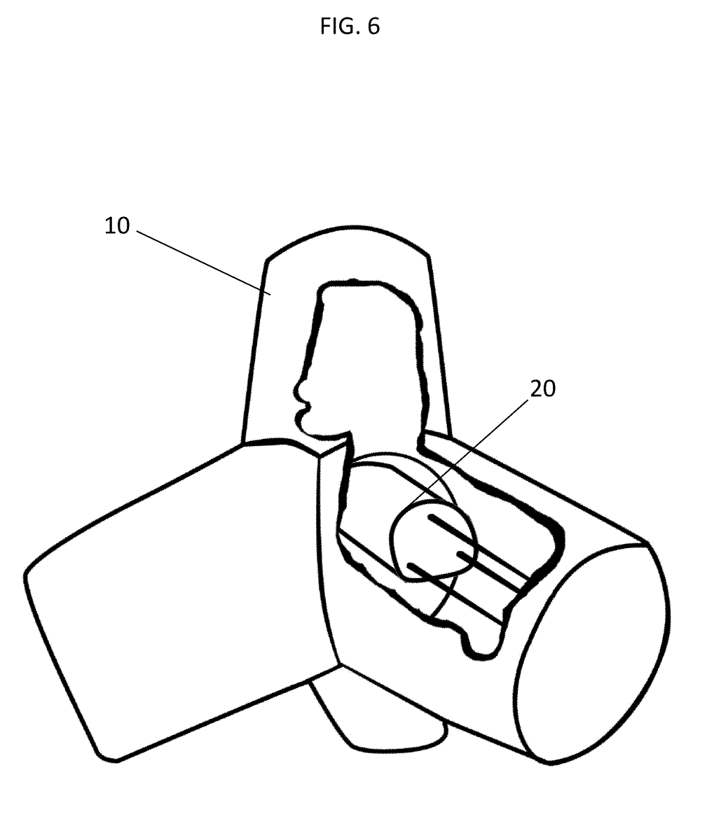

In reference to FIG. 6, according to an embodiment of the invention, a hollow body aggregate 10 is shown wherein a radio frequency (RF) antenna 20 is disposed within the hollow body. In the embodiment, the RF antenna 20 may be used to locate the position of the hollow body within the concrete solution. The RF antenna may also be in communication with a load sensor disposed within the hollow body. The sensor and RF module are able to inform on the environment of a structure in areas such as stressing, moisture, temperature, compression and expansion characteristics as well as movement and location readings of the individual sensors, along with any other relevant data mining.

In other embodiments, the RF antenna 15 may be replaced with other electronic components which may be deemed to be useful. The hollow body 10 may act a container for a variety of electronic components, insulators, or other materials deemed useful.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A geometric shaped aggregate having:
a. a body having an exterior surface shaped to promote interweaving, wherein the body is added to a concrete solution.

2. The geometric shaped aggregate of claim 1, comprised of plastic.

3. The geometric shaped aggregate of claim 1, wherein the body is a tetrapod.

4. The geometric shaped aggregate of claim 1, wherein the body is solid.

5. The geometric shaped aggregate of claim 1, wherein the body defines a hollow interior.

6. The geometric shaped aggregate of claim 5, wherein the hollow interior is filled with an adhesive solution.

7. The geometric shaped aggregate of claim 5, further comprising a radio frequency antenna disposed within the hollow interior.
